(19) United States
(12) Patent Application Publication
(10) Pub. No.: US 2022/0156840 A1
(43) Pub. Date: May 19, 2022

(54) DEVICE AND METHOD FOR PROVIDING FINANCIAL INVESTMENT PRODUCT INFORMATION BASED ON FINANCIAL INVESTMENT PRODUCT HAVING PERIODIC PROPERTY

(71) Applicant: Jung Il LEE, Seoul (KR)

(72) Inventor: Jung Il LEE, Seoul (KR)

(21) Appl. No.: 17/586,994

(22) Filed: Jan. 28, 2022

Related U.S. Application Data
(63) Continuation of application No. PCT/KR2019/010071, filed on Aug. 9, 2019.

(51) Int. Cl. G06Q 40/06

(52) U.S. Cl. CPC G06Q 40/06

(57) ABSTRACT

A method of providing financial investment product information based on a financial investment product with periodic nature by using a server, includes providing a user interface which provides information on at least one of financial investment product buying information and financial investment product selling information according to a request of a user terminal and includes plurality of pieces of financial investment product item information. Also providing detailed information on the received financial investment product item information, wherein the financial investment product item information provided in the user interface includes a financial investment product item name and expected return information at the time of selling or buying the financial investment product item, and either one of the financial investment product item name and the expected return information can be provided. Here the expected return information is calculated based on periodic nature of a market price of the financial investment product item.

### CROSS-REFERENCE TO RELATED APPLICATIONS

The present application is a continuation of International Application No. PCT/KR2019/010071, filed on Aug. 9^{th}, 2019, which is incorporated herein by reference in its entirety.

### BACKGROUND

### 1. Technical Field

The present disclosure relates to a device and a method for providing financial investment product information based on a financial investment product with periodic nature.

### 2. Related Art

In general, market prices of financial investment products are provided one by one for each period. It is difficult for a user to directly compare several financial investment product items and analyze characteristics of respective movements by using a market price of one financial investment product item.

With development of information communication, vast amounts of data may be processed by using a computer. For example, periodic nature of a market price of a financial investment product may be calculated by the computer, and financial investment product information including analysis results of whether a price of the financial investment product of a relevant item rises or falls in the future may be provided.

### SUMMARY

An object of the present disclosure is to detect only a financial investment product having a distinct periodic market price formation property and provide financial investment product information including analysis results of whether a price of a relevant financial investment product will rise or fall in the future.

According to an embodiment of the present disclosure, a method of providing financial investment product information based on a financial investment product with periodic nature by using a server, includes providing a user interface which provides information on at least one of financial investment product buying information and financial investment product selling information according to a request of a user terminal and includes a list of a plurality of pieces of financial investment product item information; receiving one of the plurality of pieces of financial investment product item information of the list which is selectively input by a user terminal; and providing detailed information on the received financial investment product item information, wherein the financial investment product item information provided in the providing of the user interface includes a financial investment product item name and expected return information at the time of selling or buying the financial investment product item, and either one of the financial investment product item name and the expected return information is provided blindly, information blinded in the providing of the detailed information is disclosed, and the expected return information is calculated based on periodic nature of a market price of the financial investment product item.

According to another embodiment of the present disclosure, a device for providing financial investment product information based on a financial investment product with periodic nature, includes a memory storing a program for performing a method of providing financial investment product information based on a financial investment product with periodic nature; and a processor configured to execute the program, wherein the processor executes the program to provide a user interface which provides information on at least one of financial investment product buying information and financial investment product selling information according to a request of a user terminal and includes a list of a plurality of pieces of financial investment product item information, receive one of the plurality of pieces of financial investment product item information of the list which is selectively input by a user terminal, and provide detailed information on the received financial investment product item information, financial investment product item information provided according to a request of the user terminal includes a financial investment product item name and expected return information at the time of selling or buying the financial investment product item, and either one of the financial investment product item name and the expected return information may be provided blindly, the blinded information is disclosed after being selectively input by the user terminal, and the expected return information is calculated based on periodic nature of a market price of the financial investment product item.

### BRIEF DESCRIPTION OF THE DRAWINGS

Various embodiments of the present disclosure will become more apparent in view of the attached drawings and accompanying detailed description, in which:

FIG. 1 is a diagram illustrating a configuration of a system for providing financial investment product information based on a financial investment product with periodic nature, according to an embodiment of the present disclosure;

FIG. 2 is a diagram illustrating the configuration of a server according to an embodiment of the present disclosure;

FIG. 3 is an operation flowchart illustrating a method of providing financial investment product information based on a financial investment product with periodic nature performed by a server, according to an embodiment of the present disclosure;

FIG. 4 is a diagram illustrating periodicity of a market price of a financial investment product according to an embodiment of the present disclosure;

FIG. 5 is an example of a screen for providing financial investment product information based on a financial investment product with periodic nature, in a user terminal illustrated in FIG. 1; and

FIGS. 6A, 6B, 7A, and 7B are diagrams illustrating expected returns for respective items according to periodicity of market prices of financial investment products.

### DETAILED DESCRIPTION OF THE EMBODIMENTS

Hereinafter, embodiments of the present disclosure will be described in detail with reference to the accompanying drawings such that those skilled in the art may easily implement the embodiment. However, the present disclosure may be embodied in several different forms and is not limited to the embodiments described herein. In order to clearly describe the present disclosure with reference to the drawings, parts irrelevant to the description are omitted, and similar reference numerals are attached to similar parts throughout the specification.

Throughout the specification, when a portion is “connected” to another portion, this includes not only a case of being “directly connected” thereto but also a case of being “electrically connected” thereto with another element interposed therebetween. In addition, when a portion “includes” a component, this means that another component may be further included therein, rather than excluding another component, unless otherwise stated, and it should be understood that existence or addition of one or more other features numbers, steps, operations, configuration elements, components, or combinations thereof is not precluded in advance.

Throughout the specification, a server 100 may indicate a device for providing financial investment product information based on a financial investment product with periodic nature.

An embodiment of the present disclosure may be applied to a financial investment product in which a task of determining whether the product has periodic nature is previously completed. Because not all financial investment products have periodic nature, an embodiment of the present disclosure has to be applied to a financial investment product with periodic nature in advance so as to derive desired effects of the present disclosure.

The following embodiments provide detailed descriptions to help understanding of the present disclosure and do not limit the scope of the present disclosure. Accordingly, an invention of the same scope for performing the same function as the present disclosure will also fall within the scope of the present disclosure.

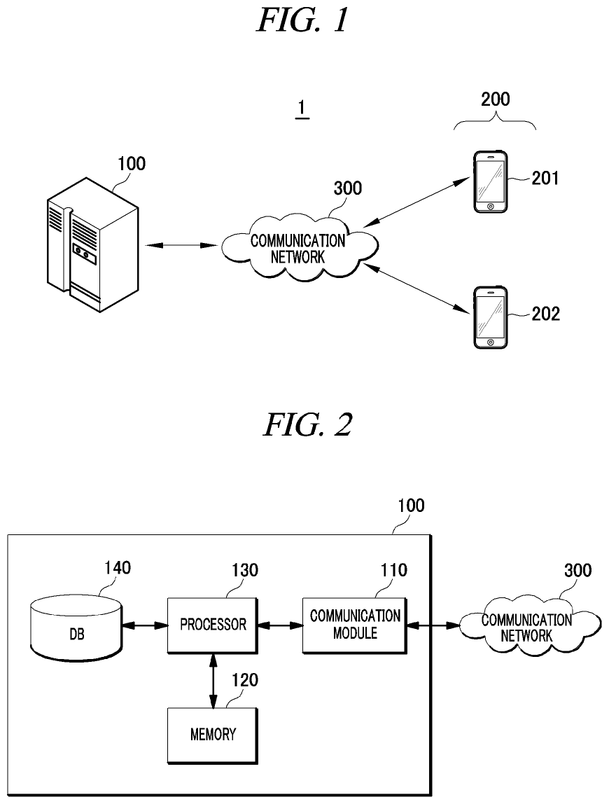

FIG. 1 is a diagram illustrating a configuration of a system 1 for providing financial investment product information based on a financial investment product with periodic nature, according to an embodiment of the present disclosure.

Referring to FIG. 1, the system 1 for providing the financial investment product information based on the financial investment product with periodic nature according to the embodiment of the present disclosure includes a server 100 and a user terminal 200. In addition, the system 1 includes a communication network 300 connecting the server 100 to a plurality of user terminals 201 and 202.

The server 100 according to an embodiment of the present disclosure provides financial investment product information to the user terminal 200, and the user terminal 200 displays the financial investment product information received from the server 100 for a user.

Here, a financial investment product refers to a finance-related investment product with a market price variation. For example, the financial investment product includes stocks, funds, derivatives, exchange traded funds (ETFs), and virtual currencies (including cryptocurrencies).

Here, the financial investment product information may include a financial investment product item name, an identification code, a financial investment product, and an expected rate of return for each of financial investment product items.

Here, the server 100 may provide the user terminal 200 with processed financial investment product information such that some information on some financial investment product items is excluded and provide full information on a relevant financial investment product item only when there is a request for the full information on the relevant financial investment product from the user terminal 200.

Here, the excluded some information may be information through which a user may easily identify which financial investment product item the relevant financial investment product item is, such as a financial investment product item name or an identification code.

The user terminal 200 may display financial investment product information received from the server 100 by using a terminal application.

The terminal application may be a dedicated application for providing financial investment product information or a web browsing application for providing financial investment product information through a web page.

Here, the dedicated application for providing financial investment product information may be an application embedded in the user terminal 200 or an application downloaded from an application distribution server to be installed in the user terminal 200.

Here, the application may be a dedicated application for providing financial investment product information or a web browsing application for providing financial investment product information through a web page.

A plurality of user terminals 201 and 202 refer to communication terminals capable of using terminal applications in a wired/wireless communication environment. Here, the user terminals 201 and 202 may be portable terminals of users. Although FIG. 1 illustrates the user terminal 200 as a smartphone which is a type of portable terminal, the idea of the present disclosure is not limited thereto, and any type of terminal in which a terminal application may be installed may be used without limitations as described above.

In more detail, the user terminal 200 may include a hand-held computing device (for example, a personal digital assistant (PDA), an email client, or so on), any type of a mobile phone, any other type of computing, or any type of communication platform, and the present disclosure is not limited thereto.

In addition, the communication network 300 serves to connect the server 100 to the user terminals 201 and 202. That is, the communication network 300 refers to a communication network for providing an access path through which the user terminals 201 and 202 may transmit and receive data after accessing the server 100. The communication network 300 may include, for example, a wired network such as local area networks (LANs), wide area networks (WANs), metropolitan area networks (MANs), or integrated service digital networks (ISDNs), or a wireless network such as wireless LANs, code division multiple access (CDMA), Bluetooth, or satellite communication, but the scope of the present disclosure is not limited thereto.

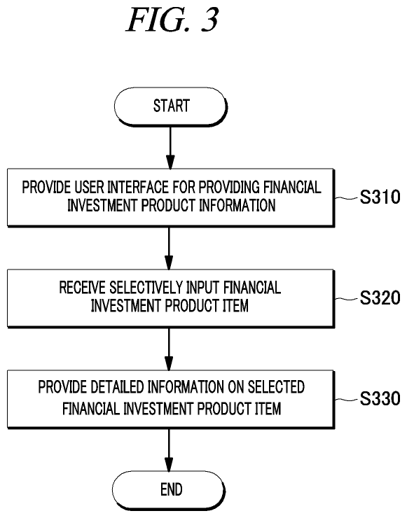

FIG. 2 is a diagram illustrating a configuration of the server 100 according to an embodiment of the present disclosure.

Referring to FIG. 2, the server 100 according to the embodiment of the present disclosure includes a communication module 110, a memory 120, a processor 130, and a database 140.

In detail, the communication module 110 provides a communication interface necessary for transmitting and receiving signals between the server 100 and the user terminal 200 in the form of packet data through the communication network 300. Furthermore, the communication module 110 may receive a data request from the user terminal 200 and transmit data thereto in response the data request.

Here, the communication module 110 may be a device including hardware and software necessary for transmitting and receiving signals such as control signals or data signals through wired/wireless communication with other network devices.

The memory 120 stores a program for performing a method of providing financial investment product information based on a financial investment product with periodic nature. In addition, the memory 120 temporarily or permanently stores data processed by the processor 130. Here, the memory 120 may include a magnetic storage medium or a flash storage medium, but the scope of the present disclosure is not limited thereto.

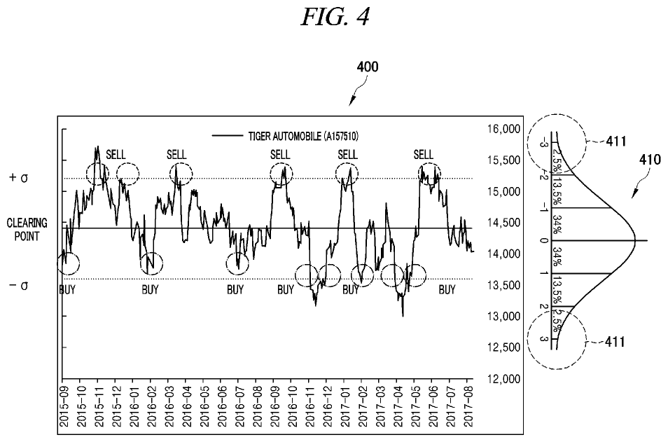

The processor 130 controls the entire process of providing financial investment product information as a kind of central processing unit. Respective performance by the processor 130 will be described below with reference to FIG. 3.

Here, the processor 130 may include all kinds of devices capable of processing data, such as a processor. Here, the “processor” may refer to, for example, a data processing device, which is embedded in hardware, including a physically structured circuit to perform a function expressed as codes or commands included in a program. For example, the data processing device embedded in the hardware as described above may include a microprocessor, a central processing unit (CPU), a processor core, a multiprocessor, an application-specific integrated circuit (ASIC), or a field programmable gate array (FPGA), but the scope of the present disclosure is not limited thereto.

The database 140 may store in advance financial investment product information to be provided to the user terminal 200.

Although not illustrated in FIG. 2, a part of the financial investment product information may be stored in a database (not illustrated) physically or conceptually separated from the database 140.

FIG. 3 is an operation flowchart illustrating a method of providing financial investment product information based on a financial investment product with periodic nature, wherein the method is performed by the server 100 according to an embodiment of the present disclosure.

Here, a program for performing respective performances of FIG. 3 is stored in the memory 120 and executed by the processor 130, and thus, a method of providing financial investment product information based on a financial investment product with periodic nature may be performed.

Referring to FIG. 3, first, the server 100 provides a user interface for providing information on at least one of financial investment product buying information and financial investment product selling information according to a request of the user terminal 200 (S310).

Here, the user interface may include a list of a plurality of pieces of financial investment product item information.

Financial investment product item information provided in 5310 may include a financial investment product item name and expected return information at the time of selling or buying a financial investment product item, and either one of the financial investment product item name and the expected return information may be provided blindly.

In addition, the financial investment product item information may be arranged based on expected return information and provided to a user.

Here, the expected return information may be calculated based on periodic nature of a market price of a financial investment product. The expected return information may include at least one of an expected rate of return and regression possibility information. That is, the financial investment product item information may be provided by considering both the expected rate of return and the regression possibility information or may be provided by considering only one of the expected rate of return and the regression possibility information.

The expected rate of return may be calculated by an equation of “(market price value of future point in time inferred through periodic pattern/current market price value of financial investment product item)−1” when the financial investment product item has a market price of a periodic pattern.

The regression probability information is information on a possibility of regression to a reference value (an average value or a value of a linear regression price line).

Specifically, normalization may be performed after an average and a standard deviation are calculated or a linear regression price line and a standard error are calculated on market price values of financial investment products collected for a certain period of time. Thereafter, when determining whether there is a difference value σ (that is, a standard deviation or a standard error) between a current market price value and the reference value described above, the larger the difference value, the higher the possibility of regression. Although details are described below, when the normalized financial investment product deviates from a certain level of sigma (for example, +/−2σ) after normalizing the graphs and setting the average value to 0 (411), the normalized financial investment product may be determined to be at an exceptional level. A financial investment product has a property of oscillating around an average price level or a linear regression price line, and also has a property of regression to an average value when the financial investment product deviates from the average value by a certain value. Through this, it may be seen that a current financial investment product has a strong regression property to a linear regression line or an average price during a corresponding period when the current financial investment product is in a range close to a preset level of sigma. For example, when the current market price corresponds to +2σ, there is a high possibility that the current market price falls rapidly in the future, and when the current market price corresponds to −2σ, there is a high possibility that the current market price increases rapidly in the future.

In addition, according to an optional embodiment, the financial investment products may be arranged by considering the regression possibility information primarily and considering the expected rate of return secondarily. That is, the financial investment products may be arranged such that a financial investment product with the highest regression possibility is provided primarily and a financial investment product with a high expected rate of return is provided secondarily.

For example, financial investment product items may be arranged based on a score obtained by applying a first weight value to a normalized conversion value of the current price of the financial investment product and applying a second weight value lower than the first weight value to the expected return information. Alternatively, when there are financial investment products that illustrate almost the same regression probability by considering regression possibility information, the financial investment products may be arranged in consideration of an expected rate of return.

Here, the user interface may arrange the financial investment product item information having the highest expected return information at the top of a list and may additionally provide a time-series graph of the financial investment product item information arranged at the top.

Here, the time-series graph may be configured with a scale in which two or more cycles may be illustrated in the graph when a market price of financial investment product item information has a repeating cycle. For example, when a time interval of a unit cycle of a preset financial investment product is 7 days, a graph of market price values for 14 days or more may be provided.

Here, the time-series graph may include a buying recommendation time and a selling recommendation time of a financial investment product item, but the buying recommendation time may be marked at a peak point where a market price is lower than an average market price within one cycle of the graph, and the selling recommendation time may be marked at a peak point where the market price is higher than the average market price within one cycle of the graph.

In an optional embodiment, the buying recommendation time and the selling recommendation time may each be selected as a point in time corresponding to a value corresponding to a preset multiple of a unit variation value (that is, a standard deviation or a standard error) by considering an average price line and a standard deviation or a linear regression price line and a standard error of the market price for a past certain period of the financial investment product item.

In an optional embodiment, the selling recommendation time and the buying recommendation time may each be selected as a current point in time when a unit variation value of the current market price is higher than an average level and the current price is lower than the average level and may be selected as the current point in time when the current price is higher than the average level.

Here, a point in time corresponding to a value corresponding to a negative multiple of the unit variation value may be selected as the buying recommendation time, and a point in time corresponding to a value corresponding to a positive multiple of the unit variation value may be selected as the selling recommendation time.

Here, the user interface may configure the list based on buying or selling, but when receiving an input of a user terminal on a buying and selling conversion button included in one region of the user interface, the list may be changed to a value corresponding to the input.

Next, the server 100 receives one piece of financial investment product item information of the list which is selectively input by the user terminal (S320).

Next, the server 100 provides detailed information on the received financial investment product item information (S330).

The information blinded in S310 may be disclosed in S330.

S330 may include requesting payment through the user terminal by considering at least one of the type of financial investment product item information selectively input by the user terminal 200, a user's account information accessed through the user terminal, and a user's activity information, and disclosing blinded information when the user terminal receives the information that the payment is completed.

Here, the user's activity information is determined based on at least one of a user's comments, the number of generated contents, the frequency of used paid services, and presence or absence of a paid member, and the number of times by which the blinded financial investment product item information may be inquired free of charge may be set differently for each user depending on a level of activity information.

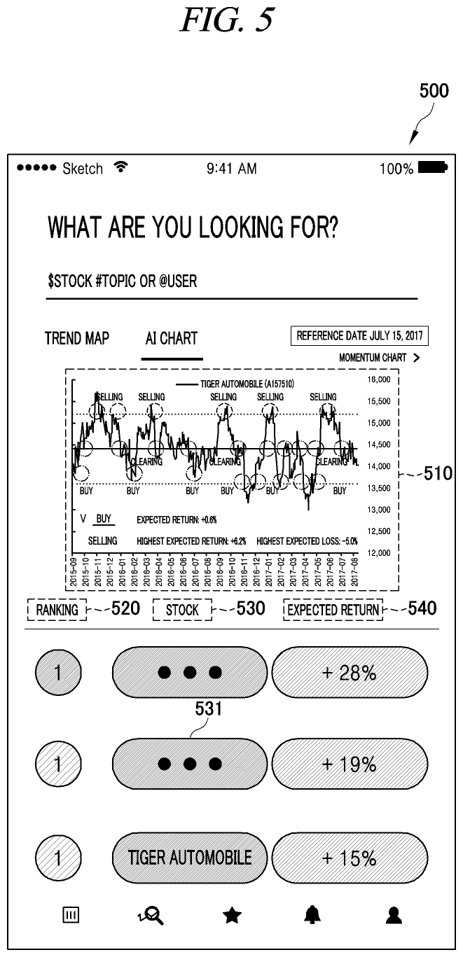

FIG. 4 is a diagram illustrating periodicity of a market price of a financial investment product according to an embodiment of the present disclosure.

Periodic nature may have in general two types: a case in which a trend exists and a case in which a trend does not exist. Here, the former case may be viewed as a trend, and the latter case may be viewed as a non-trend.

Here, the trend indicates a form in which a long-term direction of a price of a financial investment product has a slope and at the same time the slope has a periodic wave, and the non-trend indicates a form in which a long-term slope of a price flow of the financial investment products is close to zero and fluctuation of a price oscillates in the form of a wave along a horizontal line.

Several cycles of repeated fluctuations may appear even within one time series of periodic nature. For example, one time series may be represented as superposition of a large wave, a medium wave, and a small wave.

In this way, information obtained by predicting fluctuations of a financial investment product based on the number of cycles and a round-trip period for each cycle may be provided.

That is, when a price of a financial investment product representing periodic nature is currently in a position of rising or a position of falling, information on only relevant investment targets screened and appropriately ranked may be provided.

To this end, prices of many financial products for which market transaction prices exist are decomposed in time series for each waveform, and only a price of a financial product with a distinct periodic nature may be screened with a condition.

Specifically, refereeing to FIG. 4, for a financial investment product 400 of a specific item for a certain period of time, an average and a standard deviation are calculated, or a linear regression price line and a standard error are calculated, and then normalization 410 of a relevant financial investment product is performed. Next, a reference level of a unit variation value (a standard deviation or a standard error) for determining whether a normalized price level of a financial investment product is an outlier level is set. Assuming that an average price for an aggregated certain period of time or the last price of a linear regression price line is 0, when the final price (current price) of a normalized financial investment product is out of a certain level of sigma (for example, +/−3 sigma) (411), the normalized price level of the financial investment product may be determined to be an unusual level.

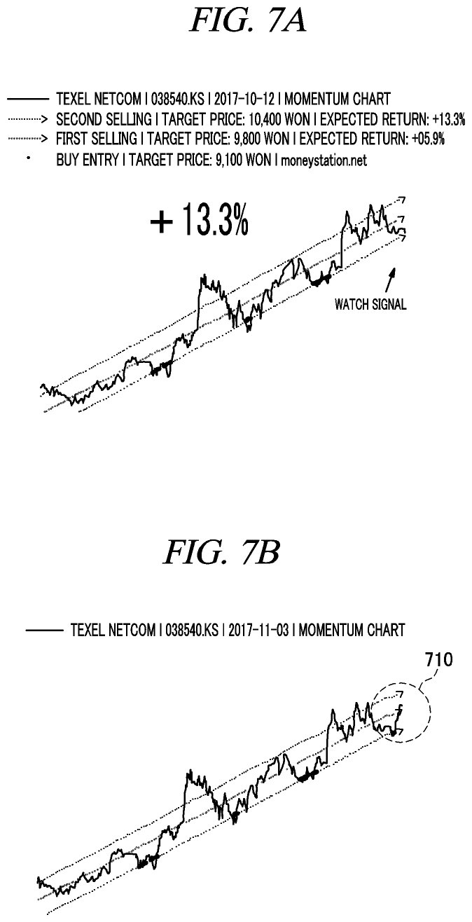

In general, a financial investment product with periodicity has a property of oscillating around an average price line or a linear regression price line and has a property of regression when deviating from the average price line (a line extending from an average value of market prices of financial investment products) or the linear regression price line by more than a certain range. Here, the linear regression price line indicates a price line of a financial investment product derived by a linear regression analysis technique. When the linear regression analysis technique is applied to market price values of financial investment products, a trend line (a middle dotted line among three blue dotted lines in a graph of FIGS. 6A and 6B or FIGS. 7A and 7B) may be derived. In addition, a value of a trend line representing an overall linear property of the linear regression price line may be referred to as a trend value.

Through this, when a current financial investment product is in a range close to a preset level of sigma, it may be seen that the financial investment product is an item with a strong regression property to a linear regression price line or an average price line.

In addition, even an item corresponding to the same preset level of sigma may have difference in expected rate of return. On the other hand, the numerical value of sigma described above is only an example, and does not limit the scope of the present disclosure.

There may be stocks of companies showing periodic nature for a long period of time, and when the number of cycles and a round-trip period for each cycle are found out, a period during which a price rises and falls may be predicted.

When a price of a stock representing periodic nature is currently in a position of rising or a position of falling, the stock may be screened and ranked.

In a further embodiment of the present disclosure, during a process of determining periodicity of a stock price, prices of a plurality of financial products for which market transaction prices exist are decomposed in time series for each waveform, and only a price of a financial product with distinct periodic nature may be screened with a criteria condition.

That is, in a case in which a distinct waveform is analyzed when decomposed into a time series waveform, a period for each cycle of each waveform may be obtained, and the period for each cycle of each waveform may become an oscillation period of a waveform.

For example, periodicity may be determined for a stock that may form a distinct waveform, such as a stock rising in a certain season such as summer or winter, a stock rapidly rising in a certain month every year, or a stock fluctuating once during a certain period.

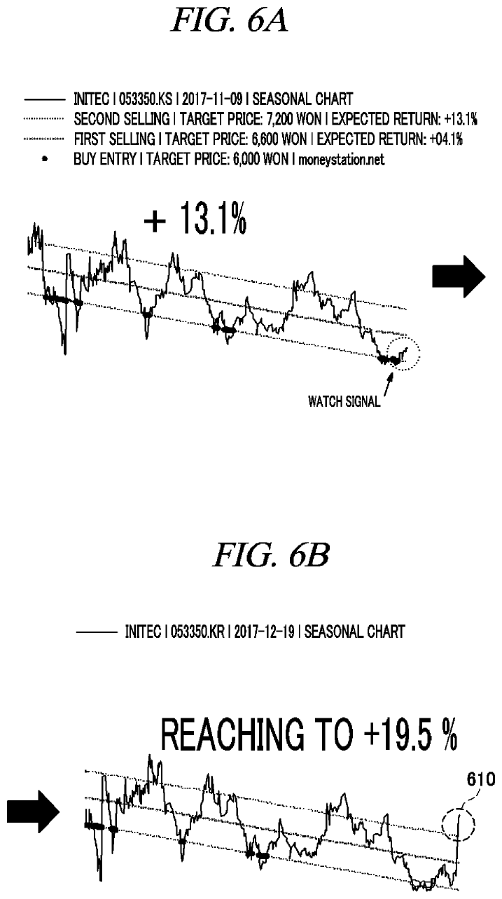

FIG. 5 is an example of a screen 500 for providing financial investment product information based on a financial investment product with periodic nature, in a user terminal illustrated in FIG. 1.

Referring to FIG. 5, the present disclosure may provide a graph 510 to a user, assign a rank 520 to items 530 based on both an average regression probability and an expected return 540 at the time of an average regression, and display the items to the user in rank order.

Here, the rank may include a rank for a buying position and a rank for a selling position.

In addition, higher-ranked items may be displayed in a state of blind processing 531. Here, when a user pays for an item subjected to the blind processing 531, the item may be disclosed.

FIGS. 6 and 7 are diagrams illustrating expected returns for respective items according to periodicity of market prices of financial investment products.

First, referring to FIG. 6A, Initec, which is an item with price seasonality and a weak trend property, falls to a price level lower than −2 sigma compared to a trend line price and is expected to return (rising of price) to a trend line.

Here, it may be seen that the expected return is +18% when returning to the trend line, and the expected return is +31% when reaching the highest level of +2 sigma.

Referring to FIG. 6B, it may be seen that a profit 610 of +28% is obtained after about 3 weeks elapse from FIG. 6A.

Referring to FIG. 7A, Texel Netcom, which is an item with price seasonality and a strong trend property, may have an expected return calculated by further considering a slope of a trend line.

Here, the expected rate of return may be represented as “(trend line price−current price)/current price”.

Referring to FIG. 7B, it may be seen that a profit 710 of +11% is obtained after about two weeks elapse from FIG. 7A.

An embodiment of the present disclosure may be implemented in the form of a recording medium including instructions executable by a computer, such as a program module executed by the computer. A computer-readable recording medium may be any available medium that may be accessed by a computer and include both volatile and non-volatile media and removable and non-removable media. In addition, the computer-readable recording medium may include a computer storage medium. The computer storage medium includes both volatile and non-volatile media and removable and non-removable media implemented by any method or technology for storing information such as computer readable instructions, data structures, program modules, or other data.

Although the method and system of the present disclosure are described with reference to some embodiments, some or all of their components or operations may be implemented by using a computer system having a general-purpose hardware architecture.

The above descriptions on the present disclosure are examples, and those skilled in the art to which the present disclosure belongs may understand that the examples may be easily modified into other specific forms without changing the technical idea or essential features of the present disclosure. Therefore, it should be understood that the embodiments described above are illustrative in all respects and not restrictive. For example, each component described as a single type may be implemented in a distributed form, and likewise components described in the distributed form may be implemented in a combined form.

The scope of the present disclosure is indicated by the following claims rather than the detailed description made above, and all changes or modifications derived from the meaning and scope of the claims and their equivalent concepts should be interpreted as being included in the scope of the present disclosure.

What is claimed is:

1. A method of providing financial investment product information based on a financial investment product with periodic nature by using a server, the method comprising:
providing a user interface which provides information on at least one of financial investment product buying information and financial investment product selling information according to a request of a user terminal and includes a list of a plurality of pieces of financial investment product item information;
receiving one of the plurality of pieces of financial investment product item information of the list which is selectively input by a user terminal; and
providing detailed information on the received financial investment product item information,
wherein the financial investment product item information provided in the providing of the user interface includes a financial investment product item name and expected return information at a time of selling or buying the financial investment product item, and either one of the financial investment product item name and the expected return information is provided blindly,
information blinded in the providing of the detailed information is disclosed, and
the expected return information is calculated based on periodic nature of a market price of the financial investment product item.

2. The method of claim 1, wherein
the plurality of pieces of financial investment product item information in the list of the user interface are arranged according to expected return information of the financial investment products, and
the expected return information includes at least one of an expected rate of return and regression possibility information of the financial investment products.

3. The method of claim 2, wherein the user interface places the financial investment product item information at a top of the list in descending order of absolute values of normalized conversion values of current market price values of the financial investment products and further provides a time-series graph of the financial investment product item information placed at the top of the list.

4. The method of claim 3, wherein the time-series graph is configured with a scale in which two or more cycles are illustrated in the graph when a market price value of the financial investment product item information has a repeating cycle.

5. The method of claim 4, wherein
the time-series graph includes a buying recommendation time and a selling recommendation time of the financial investment product item includes the time of recommendation to buy and the time to recommend selling of the financial investment product,
the buying recommendation time is marked at a peak point lower than an average value of the market price values in the graph or a value of a linear regression price line within a period set by a user, and
the selling recommendation time is marked at a peak point higher than the average value of the market price values in the graph or the value of the linear regression price line.

6. The method of claim 1, wherein
the user interface configures the list based on buying or selling, and
when receiving an input of the user terminal on a buying and selling conversion button included in one region of the user interface, the list is changed to a value corresponding to the input.

7. The method of claim 1, wherein the providing of the detailed information comprises:
requesting payment to the user terminal by considering at least one of a type of the financial investment product item information selectively input by the user terminal, account information of a user accessed through the user terminal, and activity information of the user; and
disclosing blinded information when the user terminal receives information that the payment is completed.

8. The method of claim 7, wherein
the activity information of the user is determined based on at least one of comments of the user, a number of generated contents, a frequency of used paid services, and presence or absence of a paid member, and
a number of times by which blinded financial investment product item information is inquired free of charge is set differently for each user depending on a level of the activity information.

9. The method of claim 2, wherein
the expected rate of return is calculated based on a difference between a current market price value and a market price value of a future point in time inferred through a periodic pattern of the financial investment product, and
the regression possibility information is calculated based on a difference between an average value or a value of a linear regression price line and a normalized and converted current market price value after a standard deviation or standard error-based normalization of a market price value of the financial investment product.

10. The method of claim 5, wherein the selling recommendation time and the buying recommendation time is selected as a point in time corresponding to a value corresponding to a multiple of a standard deviation on an average price line or a multiple of a standard error on the linear regression price line by considering an average value and a standard deviation of a market price value for a past period of the financial investment product item, or considering a linear regression price line and a standard error of the market price value after normalization is performed on the financial investment product item.

11. The method of claim 10, wherein a point in time corresponding to a value corresponding to a negative multiple of the standard deviation or the standard error is selected as the buying recommendation time, and a point in time corresponding to a value corresponding to a positive multiple of the standard deviation or the standard error is selected as the selling recommendation time.

12. A device for providing financial investment product information based on a financial investment product with periodic nature, the device comprising:
a memory storing a program for performing a method of providing financial investment product information based on a financial investment product with periodic nature; and
a processor configured to execute the program,
wherein the processor executes the program to provide a user interface which provides information on at least one of financial investment product buying information and financial investment product selling information according to a request of a user terminal and includes a list of a plurality of pieces of financial investment product item information, receive one of the plurality of pieces of financial investment product item information of the list which is selectively input by a user terminal, and provide detailed information on the received financial investment product item information,
financial investment product item information provided according to a request of the user terminal includes a financial investment product item name and expected return information at a time of selling or buying the financial investment product item, and either one of the financial investment product item name and the expected return information may be provided blindly,
blinded information is disclosed after being selectively input by the user terminal, and
the expected return information is calculated based on periodic nature of a market price of the financial investment product item.

13. The device of claim 12, wherein payment is requested to the user terminal by considering at least one of a type of the financial investment product item information selectively input by the user terminal, account information of a user accessed through the user terminal, and activity information of the user, and the blinded information is disclosed when the user terminal receives information that the payment is completed.

14. The device of claim 13, wherein
the activity information of the user is determined based on at least one of comments of the user, a number of generated contents, a frequency of used paid services, and presence or absence of a paid member, and
a number of times by which blinded financial investment product item information is inquired free of charge is set differently for each user depending on a level of the activity information.

15. The device of claim 12, wherein
the plurality of pieces of financial investment product item information in the list of the user interface are arranged according to expected return information of the financial investment products, and
the expected return information includes at least one of an expected rate of return and regression possibility information of the financial investment products.

16. The device of claim 12, wherein
the user interface places the financial investment product item information at a top of the list in descending order of absolute values of normalized conversion values of current market price values of the financial investment products and further provides a time-series graph of the financial investment product item information placed at the top of the list,
the time-series graph is configured with a scale in which two or more cycles are illustrated in the graph when a market price value of the financial investment product item information has a repeating cycle,
the time-series graph includes a buying recommendation time and a selling recommendation time of the financial investment product item includes the time of recommendation to buy and the time to recommend selling of the financial investment product, the buying recommendation time is marked at a peak point lower than an average value of the market price values in the graph or a value of a linear regression price line within a period set by a user, and the selling recommendation time is marked at a peak point higher than the average value of the market price values in the graph or the value of the linear regression price line, and
the selling recommendation time and the buying recommendation time is selected as a point in time corresponding to a value corresponding to a multiple of a standard deviation on an average price line or a multiple of a standard error on the linear regression price line by considering an average value and a standard deviation of a market price value for a past period of the financial investment product item, or considering a linear regression price line and a standard error of the market price value after normalization is performed on the financial investment product item.

17. The device of claim 16, wherein a point in time corresponding to a value corresponding to a negative multiple of the standard deviation or the standard error is selected as the buying recommendation time, and a point in time corresponding to a value corresponding to a positive multiple of the standard deviation or the standard error is selected as the selling recommendation time.

18. A non-transitory computer-readable recording medium storing a program for performing the method of providing financial investment product information based on a financial investment product with periodic nature according to claim 1.
